(19) United States
(12) Patent Application Publication
(10) Pub. No.: US 2022/0399603 A1
(43) Pub. Date: Dec. 15, 2022

(54) COMPARTMENT FOR AN ELECTRICAL ENERGY STORAGE DEVICE OF A MOTOR VEHICLE

(71) Applicant: Valeo Systemes Thermiques, Le Mesnil Saint-Denis (FR)

(72) Inventors: Sergio Da Costa Pito, Le Mesnil Saitn Denis (FR); Guillaume Gardere, Le Mesnil Saint Denis (FR)

(73) Assignee: Valeo Systemes Thermiques, Le Mesnil Saint-Denis (FR)

(21) Appl. No.: 17/776,093

(22) PCT Filed: Oct. 8, 2020
(86) PCT No.: PCT/FR2020/051770

§ 371 Date: May 11, 2022

(30) Foreign Application Priority Data
Nov. 15, 2019 (FR) FR1912803

(51) Int. Cl. H01M 50/24; H01M 10/6556; H01M 10/6567

(52) U.S. Cl. CPC H01M 50/24; H01M 10/6556; H01M 10/6567; H01M 2220/20

(57) ABSTRACT

The invention relates to a compartment (10) for an electrical energy storage device of a motor vehicle, the compartment (10) being configured to receive at least one electrical energy storage cell (14), the compartment (10) comprising: a housing (16) comprising a base wall (26) and at least one side wall (28), and a cover (18) which is configured to close the housing (16). According to the invention, the compartment (10) comprises an electromagnetic protection cage.

The invention relates to an electrical energy storage device for a motor vehicle, comprising a compartment and at least one electrical energy storage cell accommodated in the casing. The invention relates in particular to said compartment. The invention also relates to a vehicle comprising such an electrical energy storage device.

In the automotive field, it is known practice to use electric batteries in the form of modules. Each module comprises of a plurality of electrical energy storage cells accommodated in a casing. This makes it easier to combine the electric batteries so as to obtain a desired charge capacity. It is also easier, in this way, to mount the battery on the motor vehicle, the storage cells being protected by the casing.

Although such a compartment is suitable for containing electrical energy storage cells, the battery is subject to electromagnetic stresses originating from the various items of electronic equipment on the vehicle, such as the ECU (electronic control unit), which can cause interference and the malfunctioning of the battery, known as electromagnetic interference (EMI).

The invention therefore seeks to overcome this drawback and proposes an electrical energy storage device for a motor vehicle, comprising a casing with protection against this electromagnetic interference.

To this end, the invention proposes a compartment for an electrical energy storage device of a motor vehicle, said compartment being configured to accommodate at least one electrical energy storage cell, the compartment comprising:
a. a casing comprising a bottom wall and at least one side wall,
b. a cover arranged to close said casing.
   According to the invention,
c. the compartment comprises an electromagnetic protection cage.

One aspect according to the invention proposes that the cover and the casing comprise of a conductive material so as to ensure electrical continuity between the cover and the casing.

Another aspect according to the invention proposes that the casing and/or the cover comprise(s) a network of ribs comprising a plastic material with metal and/or carbon fibers and/or any other fibers having the property of conducting electricity.

Another aspect according to the invention proposes that the network of ribs is distributed uniformly so as to define regular grid cells.

Another aspect according to the invention proposes that the compartment further comprises a connecting element configured to be connected to an electrical grounding point. In other words, the compartment further comprises a connecting element configured to be connected to a ground electrode.

The invention also relates to an electrical energy storage device for a motor vehicle, comprising a compartment as previously described and at least one electrical energy storage cell, in particular a plurality of cells, accommodated in said compartment.

One aspect according to the invention proposes that the device comprises at least one heat exchanger and that the ribs ensure electrical continuity with the heat exchangers and between the cover and the casing.

The invention also relates to a motor vehicle comprising an electrical energy storage device as described above, in which the compartment comprises an element for connection to the vehicle in order to supply it with electrical energy.

One aspect according to the invention proposes that the ground electrode corresponds to the chassis of the vehicle.

Further embodiments propose that the bottom wall comprises a composite material.

Said compartment comprises at least one channel for the flow of a coolant, said channel being at least partially formed by the bottom wall, said channel comprises a furrow formed at least partially by the bottom wall and a lid arranged to close this furrow and thus form the channel. According to the invention, the casing comprises of a ductile material.

Ductile material is given to mean a material that can be stretched without fracturing or failing. In other words, it is a malleable, resilient, stretchable, flexible, supple or extendible material, in other words capable of withstanding the propagation of a crack or fracture. More particularly, the material according to the invention preferably has an elongation at break (A %) greater than or equal to 50%, or an energy required to cause a fracture greater than 26 Pa, in other words, an ultimate tensile strength greater than 26 Pa. It will be understood that if an element comprises a material, this means that this element is made from this material, in other words, this element is manufactured using this material. It could also be said that the casing comprises a material giving it an ability to deform, without failing, in the event of an impact; that is, it can absorb an acceptable quantity of energy in the event of an impact. In other words, it has a high capacity for plastic deformation without failing, breakage occurring when a fault such as a crack or cavity, caused by plastic deformation, becomes critical and propagates, the material therefore having a great ability to withstand this propagation.

Elongation at break, represented by the term “A %”, is defined by the following formula:

$$A \% = 100 \cdot \frac{{L}_{u} - {L}_{o}}{{L}_{o}} \qquad [ Math . 1 ]$$

Lᵤ corresponds to the ultimate length, that is, the length of the element, here the element of the casing comprising the ductile material, just before break. Lo corresponds to the initial length, the length of the element before the start of a tensile strength test.

As stated previously, the casing can comprise an element, which can be a wall, a rib or a lid, having an elongation at break greater than or equal to 50%. The ductile material, that is, material able to withstand significant plastic deformation, preferably has a tensile capacity greater than 50%. This material is preferably a non-reinforced polymer such as for example a modified polypropylene or any polyethylene-polyamide containing a certain elastomer percentage.

Another embodiment proposes that a side wall is connected to the bottom wall, a fluid connecting element being arranged to make it possible to connect the channel to an external coolant circuit, the connecting element being at least partially overmolded on, or with, the bottom wall or the side wall. Each channel communicates with an associated connecting element, in order to allow the supply or discharge of coolant to or from the channel via the external circuit.

Further features and advantages of the invention will become apparent on reading the following description. This description is purely illustrative and must be read with reference to the appended drawings.

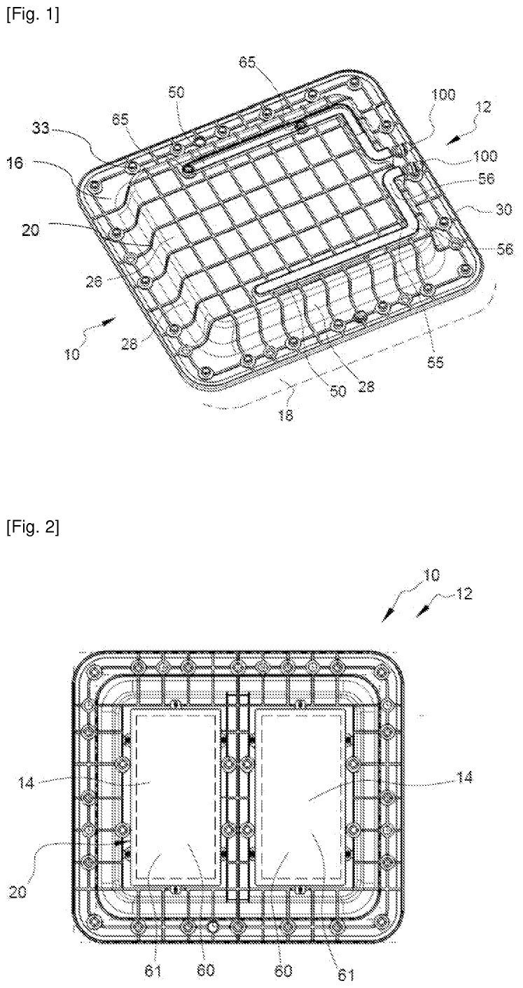

FIG. 1 and FIG. 2 are views of an exemplary embodiment of the invention.

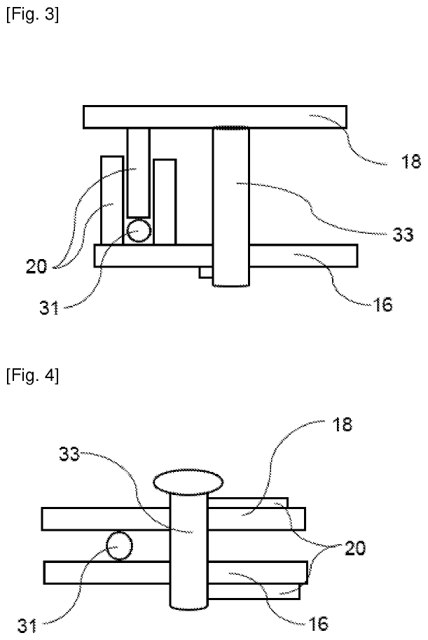

FIG. 3 and FIG. 4 schematically illustrate a cross-section of the compartment according to the invention.

The invention relates to a compartment 10 configured to accommodate electrical energy storage cells as illustrated in FIG. 1. Said compartment 10 comprises a casing 16 and a cover 18. Said casing 16 comprises a bottom wall 26, the bottom wall 26 comprises a composite material, side walls 28 connected to the bottom wall 26 so as to define a housing for accommodating the electrical energy storage cells, and at least one channel 50, here two in number, for the flow of a coolant, each channel 50 being at least partially formed by the bottom wall 26.

The casing 16 further comprises fluid connecting elements 100 arranged to make it possible to connect the channels 50 to an external coolant circuit, not shown, each connecting element 100 being at least partially overmolded with the bottom wall or the side wall.

This housing 16 forms the lower part of the compartment 10 which accommodates battery cells. The cover 18 forms the upper part of the compartment 10. The cover 18 comprises fastening means having a shape that complements the fastening means arranged on the casing 16. The cover 18 can thus close the casing 16 and thus form the compartment 10. The fastening means can correspond to a threaded screw and the corresponding internal thread, a nut and corresponding bolt, clips with complementary male and female parts, hooks and a hole, etc.

In order to protect the batteries from any electromagnetic interference, the compartment 10 according to the invention comprises a Faraday cage, that is, a conductive enclosure impermeable to electric fields. This can also be referred to as electromagnetic shielding.

According to one embodiment, the addition of a metal layer around the entire compartment 10 can be envisaged, that is, the cover 18 and the casing 16 can be made from metal, such as aluminum, or can be made from plastic with an additional metal layer.

According to another embodiment, the compartment 10, in particular the cover 18 and the casing 16, comprises a conductive material so as to ensure electrical continuity between the cover 18 and the casing 16.

The casing 16 and the cover 18 are for example each made from a plastic material or from a sheet of composite material, that is a resin, which can comprise reinforcing fibers, such as glass fibers, pre-impregnated with thermoplastic resin. According to the invention, the casing 16 and the cover 18 further include at least one conductive material in order to ensure electrical continuity. For example, the casing 16 and the cover 18 further include carbon fibers and/or metal fibers. The casing 16 and the cover 18 can also include metal particles.

In summary, the conductive material corresponds to a conductive plastic material or composite.

According to a particular embodiment, the cover 18 and the casing 16 each comprise overmolded or bi-injection molded ribs 20, said ribs 20 comprising carbon and/or metal fibers. The ribs 20 as illustrated in FIG. 1 form a uniform network of ribs with grid cells having a regular or identical shape or size, with parallel and/or perpendicular ribs so as to form a grid. Obviously, the invention is not limited to the shape of the network of ribs and this network can be irregular, with grid cells of different shapes.

The ribs 20 can for example ensure the join between the cover 18 and the casing 16, for example in line with the complementary fastening means 33 as illustrated in FIG. 4, or through a system of interlocking of the ribs 20 in which the cover 18 can have a rib 20 arranged to be inserted between two juxtaposed ribs 20 arranged on the casing 16 as illustrated in FIG. 3, a seal 31 being capable of being arranged between the ribs 20 or between the casing 16 and the cover 18. In FIG. 4, the fastening means 33 correspond to a threaded metal screw passing through the walls of the cover 18 and the casing 16, each comprising an internal thread, or screw pitch, complementary to the threaded stem, and in FIG. 3, to a hook with a corresponding hole. In order to ensure electrical continuity, in the embodiment illustrated in FIG. 4, each rib 20 abuts against the fastening element 33.

The network of ribs 20 thus ensures electrical continuity between the cover 18 and the casing 16.

A seal 31 comprising a conductive material can also be used in order to ensure electrical continuity between the cover 18 and the casing 16.

Certain materials have a conductivity and magnetic permeability suitable for ensuring electromagnetic shielding in themselves; nickel and iron alloys are particularly suitable, and are more commonly known as mu-metal. In other words, it is not necessary to connect to the compartment to ground if it comprises mu-metals. Other metals such as copper or aluminum also have good magnetic properties; however, it can be useful for a compartment 10 comprising such metals to be connected to ground in order to discharge the excess electricity. In other words, the compartment 10 according to the invention can comprise a connecting element configured to be connected to an electrical grounding point, or in other words, to a ground electrode. The electrical grounding point can for example correspond to the chassis of the vehicle.

The invention also relates to an electrical energy storage device for a motor vehicle, comprising a compartment 10 as previously described and at least one electrical energy storage cell 14, in particular a plurality of cells 14, accommodated in said casing 16.

According to another aspect according to the invention, as the heat exchangers 60 are made from metal plates or tubes, they can contribute to the electromagnetic shielding, and the ribs 20 can ensure electrical continuity with the heat exchangers 60 in order to form the Faraday cage.

Obviously, the electrical energy storage device according to the invention is configured to supply the vehicle with electrical energy as a function of the requirements of the motor. To this end, the compartment can further comprise an element for connection to the vehicle in order to supply it with electrical energy.

According to another embodiment, the casing 16 can comprise a channel 50 for distributing coolant, or refrigerant, and a channel 50 for collecting coolant, each channel communicating with an associated connecting element, as described above, in order to make it possible to supply the distribution channel via the external circuit and discharge the refrigerant via the external circuit, respectively.

The casing 16 therefore comprises a bottom wall 26, at least one side wall 28 connected to the bottom wall 26 and a rim 30 connected to the side wall 28. Side wall 28 is given to mean a wall that is connected, in other words linked, to the bottom wall 26, over the entire perimeter of the bottom wall 26. The side wall 28 can also be considered to comprise four faces, or parts, connected to each other by rounded corners. Likewise, the rim 30 comprises four faces, or parts, connected to each other by rounded corners; in other words, the rim 30 is connected, or linked, to the side wall 28, over the entire perimeter of the side wall 28. The ribs 20 can be arranged on the bottom wall 26 and/or the side wall 28 and/or the rim 30.

As illustrated in FIG. 1, fastening means 33 are arranged on the rim 30. In order to make it possible to fasten the cover 18 to the casing 16, fastening means 33 must be arranged on the casing 16, here on the surface of the rim 30. Here, the fastening means 33 correspond to a tapped hole.

As illustrated in FIG. 1, each channel 50 comprises of a furrow 51 formed by the bottom wall 26 and a lid 55 arranged to close this furrow 51 and thus form the channel 50, the closure taking place in particular by welding this lid onto the bottom wall.

Each lid 55 is elongate in shape and is substantially flat.

Each lid 55 comprises, in order to match an elbow of the channel, in particular two elbows 56.

One of the ends of the lid of the channel 50 is facing the connecting element 100.

The furrow 51 communicates with a plurality of orifices 65, so that the coolant communicates with one or more heat exchangers 60.

These heat exchangers 60 are in particular each a plate 61 with internal channels for the flow of coolant.

Each lid 55 covers less than 10%, in particular 5%, of the surface area of the bottom wall 26.

The coolant used in this case can in particular be a liquid refrigerant based on carbon dioxide, such as R744 for example, 2,3,3,3-tetrafluoropropene (or HFO-1234yf) or 1,1,1,2-tetrafluoroethane (or R-134a). The coolant can also be a nanofluid. The coolant can also be water, optionally including additives.

1. A compartment for an electrical energy storage device of a motor vehicle, said compartment being configured to accommodate at least one electrical energy storage cell, the compartment comprising:
a casing comprising a bottom wall and at least one side wall; and
a cover arranged to close said casing,
wherein the compartment comprises an electromagnetic protection cage.

2. The compartment as claimed in claim 1, in which the cover and the casing comprises a conductive material so as to ensure electrical continuity between the cover and the casing.

3. The compartment as claimed in claim 1, in which the casing and/or the cover comprise(s) a network of ribs comprising a plastic material with metal and/or carbon fibers.

4. The compartment as claimed in claim 3, in which the network of ribs is distributed uniformly so as to define regular grid cells.

5. The compartment as claimed in claim 3, in which the compartment further comprises a connecting element configured to be connected to an electrical grounding point.

6. An electrical energy storage device for a motor vehicle, comprising a compartment as claimed in claim 5; a plurality of cells accommodated in said compartment.

7. The electrical energy storage device as claimed in claim 6, further comprising: at least one heat exchanger, in which the ribs ensure electrical continuity with the heat exchangers and between the cover and the casing.

8. A motor vehicle comprising an electrical energy storage device as claimed in claim 6, in which the compartment further comprises an element for connection to the vehicle in order to supply it with electrical energy.

9. The motor vehicle as claimed in claim 8, in which the electrical grounding point corresponds to the chassis of the vehicle.
